(19) United States
(12) Patent Application Publication
(10) Pub. No.: US 2013/0216469 A1
(43) Pub. Date: Aug. 22, 2013

(54) METHOD OF MANUFACTURING INFRARED SENSOR MATERIAL, INFRARED SENSOR MATERIAL, INFRARED SENSOR DEVICE AND INFRARED IMAGE SENSOR

(71) Applicant: Shoji Sekino, Tokyo (JP)

(72) Inventor: Shoji Sekino, Tokyo (JP)

(21) Appl. No.: 13/821,826

(22) PCT Filed: Sep. 1, 2011
(86) PCT No.: PCT/JP2011/004898

§ 371 Date: May 8, 2013

(30) Foreign Application Priority Data
Oct. 13, 2010 (JP) 2010-230225

(51) Int. Cl. C01B 31/02; C01B 31/00

(52) U.S. Cl. CPC C01B 31/0273; C01B 31/00
USPC 423/447.2; 423/447.1; 252/502

(57) ABSTRACT

A method of manufacturing an infrared sensor material includes preparing a CNT dispersion solution by dispersing a Carbon Nanotube (CNT) in a solvent, forming a CNT thin film using the CNT dispersion solution as a raw material, and annealing the CNT thin film so that an absolute value of the temperature coefficient of resistance is equal to or more than 1%/K at a temperature of −10° C. to 50° C.

### TECHNICAL FIELD

The present invention relates to a method of manufacturing an infrared sensor material suitable for a bolometer material used in an uncooled type infrared sensor, an infrared sensor material manufactured by the same method, an infrared sensor device using the infrared sensor material, and an infrared image sensor using the infrared sensor device.

### BACKGROUND ART

All materials radiate an infrared radiation originated from a temperature of a material itself. A device that senses infrared radiations and detects the temperature of an observation target is generally referred to as an infrared sensor. Such an infrared sensor array at a micro-level is used in an infrared imaging technique.

Since the infrared imaging technique enables the temperature of the observation target to be imaged, it is possible to perform video recording even in a dark visual field such as at night. Therefore, the infrared imaging technology has become an essential technology in security cameras, surveillance cameras, and the like. In addition, in recent years, infrared imaging techniques have attracted attention even for use in distinguishing a person with a fever due to influenza, and the like.

The infrared radiation is a general term of an electromagnetic wave having a longer wavelength region than a visible light. A near-infrared radiation (up to approximately 3 μm), amid-infrared radiation (approximately 3 μm to 8 μm), a far-infrared radiation (approximately 8 μm to 14 μm), and the like are wavelength ranges used in infrared sensors.

The far-infrared radiation is particularly important in an infrared sensor observing the living environment of a human being as an observation target due to reasons that little of the far-infrared radiation is absorbed by the air and human body temperature radiates the far-infrared radiation around 10 μm.

As an infrared sensor material, a quantum-type infrared sensor in which H_{g}C_{d}Tₑ is used as the sensor material of the sensor has been widely used. However, the quantum-type infrared sensor requires a cooling device for cooling the temperature of the equipment since the device temperature needs to be cooled to at least the temperature of liquid nitrogen (77 K). Therefore, the quantum-type infrared sensor has a limitation on the miniaturization of the equipment.

Therefore, in recent years, the uncooled type infrared sensor in which the device does not need to be cooled down to a low temperature has widely spread as the infrared sensor material. As the uncooled type infrared sensor, a bolometer has been widely used. The bolometer is based on a principle of detecting a change in electrical resistance due to a temperature change in the device. In particular, as the bolometer material, a material has been commercialized in which vanadium oxide (hereinafter, abbreviated as VOx), amorphous Si, or the like is formed in a thin film shape.

As a performance index of the bolometer, there are several parameters. A temperature change rate (a value obtained by dividing the temperature change rate of resistance by a resistance value) of the electrical resistance, which is referred to as a temperature coefficient of resistance (TCR) and a parameter which is referred to as specific resistance are particularly important.

More specifically, the material which has a high absolute value of TCR and a low specific resistance is small has been required. As the material used for the bolometer, the material which shows a semiconductor-like property is suitable. The TCR becomes a negative value.

At present, it has been also reported that the VOx, which is used for the uncooled type bolometer has a TCR exceeding approximately −4%/K at room temperature (refer to Patent Document 1). At the level of mass-production, a product having a level, −1.5%/K, has been used.

However, various crystalline phases are present in the VOx, each showing a unique property. In forming the VOx film, due to the reason of it being difficult to maintain a constant mixing ratio of the crystalline phases and the like, performance variation between arrays is not necessarily small enough when arrayed, even inside the same wafer.

Further, when forming the VOx film, since there is a need to introduce a dedicated process rather than a normal silicon process, there is a limitation in that the production line itself should be a VOx dedicated line. In addition, there is a possibility that the annealing temperature may be increased to 400° C. or more, and thereby an influence on the wiring, or the like is of concern.

In addition, in the 1990s, a bolometer was developed which is obtained by using amorphous Si that is available through a start-to-finish production using the silicon process, as the sensor material. The amorphous Si is advantageous in productivity since the manufacturing process is able to be simplified.

However, the amorphous Si also has a problem in that extraordinarily large specific resistance is present and it is difficult to uniformize the crystal structure (amorphous). Under such circumstances, studies using a CNT thin film as the infrared sensor material, have recently been reported (refer to Patent Document 1). In particular, among CNTs, it has been proposed that the single-wall nanotube (hereinafter, SWNT: Single Wall Carbon Nanotube) can be effectively used.

The SWNT thin film disclosed in Patent Document 1, for example, includes a film which is formed through suction-filtering of the CNT dispersed in a solvent, and a film in which a stainless steel mesh is composed on the spot as a base material. Particularly, there has been reported that the latter indicates a high temperature coefficient of resistance (TCR).

In addition, there has also been a proposal that more clearly shows a point of utilizing properties whereby the infrared wavelength, which is absorbed by the infrared sensor, depends on the diameter of the CNT (refer to Patent Document 2).

As an attempt to change the properties of the CNT thin film, annealing the CNT thin film and the like has been proposed (refer to Patent Document 3). However, Patent Document 3 utilizes an effect that a polymer is mixed into the CNT thin film and the properties of the polymer are changed through the annealing. In addition, Patent Document 3 discloses that the CNT thin film is used as a conductive thin film, but there is no mention of being used as a material for the infrared sensor.

Moreover, since the CNT has a good dispersibility in a solvent such as a dichloroethane having a high volatility, it is possible to use a process with a relatively good productivity, such as a spin coating method, a coating method, a printing method, or the like. Therefore, the CNT does not necessarily need the equipment for a large-scale process, such as the silicon process.

### RELATED DOCUMENT

### Patent Document

[Patent Document 1] U.S. Pat. No. 7,723,684B1
[Patent Document 2] Japanese Unexamined Patent Application No. 2003-282924
[Patent Document 3] Japanese Unexamined Patent Application No. 2009-074072

### DISCLOSURE OF THE INVENTION

As an infrared sensor material in the related art, materials such as VOx, and the like have been commercially distributed. However, a silicon process is not always highly matched with forming the VOx film, whereby a decreased productivity of an infrared sensor is caused.

Further, as the infrared sensor material, amorphous silicon is also widely distributed. However, since it is still necessary to use the silicon process, there is a problem in that it is difficult to improve the productivity over a certain level.

The TCR of a CNT thin film disclosed in Patent Document 1 has a high degree of temperature dependence and thus a sufficient TCR can be obtained at near the temperature of liquid nitrogen. Therefore, the CNT thin film disclosed in Patent Document 1 has a problem in that a sufficient TCR cannot be obtained at room temperature.

In the principle that has been disclosed in Patent Document 2, since a band gap depending on the diameter of the SWNT is used, there is a need to perform the process at a low temperature, like a quantum-type infrared sensor such as H_{g}C_{d}Tₑ. Therefore, the principle disclosed in Patent Document 2 is not suitable for a use at near room temperature.

The CNT thin film disclosed in Patent Document 3 has a problem in that the film has to be thickened in order to lower the electrical resistance since a polymer is a main component.

The present invention is made in view of such problems as described above, and is to provide a method of manufacturing an infrared sensor material which can be manufactured with a relatively better productivity than that in the related art, through performing annealing process for a CNT thin film capable of being manufactured with a relatively better productivity, at a relatively low temperature.

A method of manufacturing an infrared sensor material according to the present invention includes preparing a CNT dispersion solution by dispersing a Carbon Nanotube (CNT) in a solvent, forming a CNT thin film using the CNT dispersion solution as a raw material, and annealing the CNT thin film so that an absolute value of a temperature coefficient of resistance is equal to or more than one %/K at a temperature of −10° C. to 50° C.

An infrared sensor material according to the present invention is manufactured using a manufacturing method of the present invention, wherein the absolute value of the temperature coefficient of resistance is equal to or more than one %/K.

An infrared sensor material according to the present invention includes a CNT thin film in which the absolute value of the temperature coefficient of resistance is equal to or more than one %/K at −10° C. to 50° C.

An infrared sensor device according to the present invention uses the infrared sensor material of the present invention.

An infrared image sensor according to the present invention has a configuration in which the infrared sensor devices of the present invention are arranged two-dimensionally.

According to the manufacturing method of the present invention, since a relatively simple CNT thin film is formed, process productivity can be improved. In addition, even through the annealing at a relatively low temperature equal to or less than 300° C., an infrared sensor material with a sufficiently large TCR can be obtained. More specifically, it is possible to obtain an infrared sensor material having the absolute value of TCR at −10° C. to 50° C. exceeding one %/K. In a case of utilizing this advantage, it is not necessary to always use a silicon substrate. For example, using a plastic substrate such as a polyimide substrate, an infrared sensor having a good productivity can also be manufactured.

### BRIEF DESCRIPTION OF THE DRAWINGS

The object described above and other objects, features and advantages will become more apparent from preferred embodiments described below with reference to the accompanying drawings.

FIG. 1 is a cross-sectional view along the line A-A′ and is a plan view of one device of the infrared sensor according to an embodiment of the present invention.

FIG. 2 is a plan view of an infrared sensor.

FIG. 3 is a flowchart of a process of manufacturing a CN thin film.

FIG. 4 illustrates a surface SEM image of a CNT thin film.

FIG. 5 is a graph illustrating an annealing temperature dependency of TCR of a CNT thin film.

FIG. 6 is a graph illustrating an annealing temperature dependency of electric resistance of a CNT thin film.

### DESCRIPTION OF EMBODIMENTS

Hereinafter, embodiments of the present invention will be described with reference to the drawings. Further, it should be noted that in all the drawings, the same reference numerals are given to similar elements and descriptions thereof will be omitted as appropriate. However, the structures and configurations illustrated in the exemplary embodiment are examples demonstrating an advantage thereof. The structures and configurations are not limited to those disclosed below.

A method of manufacturing an infrared sensor material according to the embodiment of the present invention includes preparing a CNT dispersion solution by dispersing a Carbon Nanotube (CNT) in a solvent, forming a CNT thin film using the CNT dispersion solution as a raw material, and performing a annealing process on the formed CNT thin film so that the CNT thin film has an absolute value of a temperature coefficient of resistance (TCR) equal to or more than one %/K.

According to the manufacturing method of the present embodiment, since a relatively simple CNT thin film is formed, process productivity is able to be improved. In addition, even through the annealing at a relatively low temperature of equal to or less than 300° C., an infrared sensor material with a sufficiently large TCR is able to be obtained.

More specifically, according to the manufacturing method of the present embodiment, it is possible to obtain an infrared sensor material in which the absolute value of TCR exceeds one %/K. When utilizing these advantages, a silicon substrate need not necessarily be used, for example, and it is possible to manufacture an infrared sensor with good productivity using a plastic substrate, such as a polyimide substrate. A more detailed explanation will be described below.

### [Dispersion Solution Adjusting Method]

The CNT dispersion solution can be obtained by dispersing the CNT (SWNT) in an appropriate solvent. As the solvent, for example, 1 and 2-dichloroethane (hereinafter, referred to as dichloroethane), and the like are suitable.

However, the solvent is not limited to those listed above, and those having a high dispersibility of the CNT and a high volatility being suitable. As such solvents, for example, organic solvents such as DMF (N and N-dimethylformamide), alcohol based solvents such as methanol, ethanol and IPA (Isopropyl Alcohol), ketone based solvents such as acetone, and additionally polar solvents such as water can be used.

### [Thin Film Manufacturing Method]

As the method of manufacturing the thin film, a spin coating method, a dropping method, a printing method or the like can be used. When forming the film, it is preferable to perform a single drop, but plural drops may be performed in order to obtain a predetermined film thickness. However, the method of manufacturing the film is not limited to the method described above, and other methods may be used.

### [Annealing Process of CNT Thin Film]

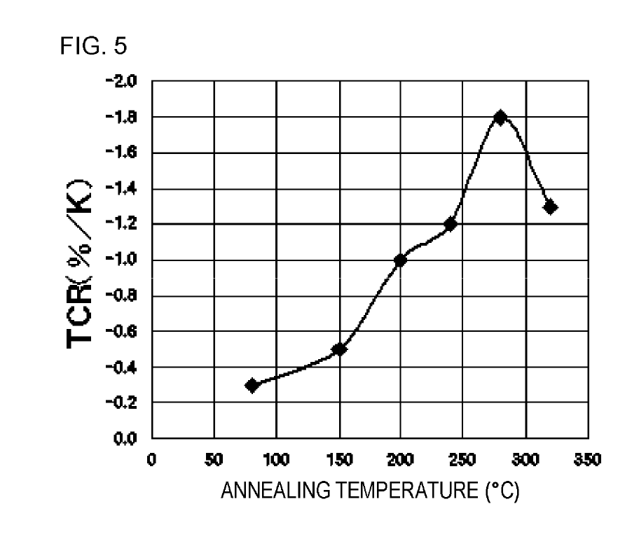

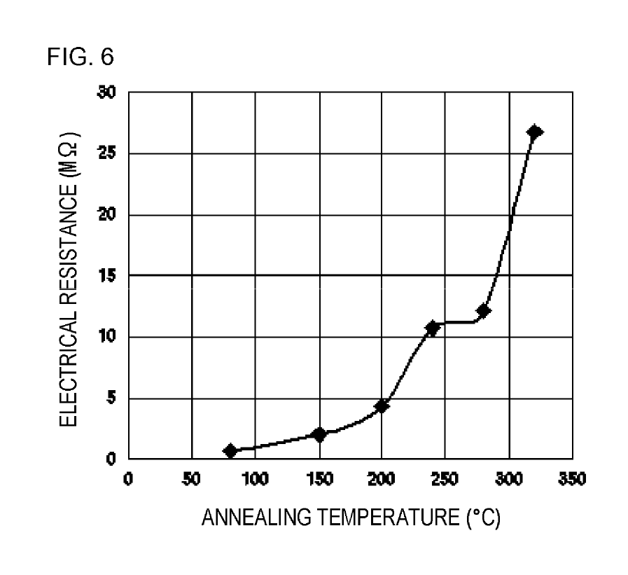

With regard to the CNT thin film, it is preferable to form the film within a range of 150° C. to 350° C. in the air. Forming within a range of 200° C. to 340° C. is more preferable. Forming within a range of 240° C. to 320° C. is most preferable. In the illustrated results in FIGS. 5 and 6, in the sample annealed at approximately 280° C., the temperature coefficient of resistance is the largest and the electrical resistance is also small. Accordingly the balance between the electrical resistance and the temperature coefficient of resistance is most preferable.

With regard to a lower limit temperature, some advantageous effects are obtained even by 150° C. annealing, and at 200° C. and 240° C., the temperature coefficient of resistance becomes yet larger. In addition, with regard to an upper limit temperature, if the temperature exceeds 300° C., the CNTs themselves are destroyed. Therefore, the upper limit value is lowered corresponding to the lower limit value and thus the range thereof is further limited. With regard to the electrical resistance, at equal to or more than 320° C., further increase is expected and the TCR is also exhibits a decreasing trend. Therefore, finally, 320° C. is the optimal value of the upper limit. However, in practice, it is preferable to suppress the temperature to approximately 300° C. Based on the above idea, a temperature range of 240° C. to 320° C. was finally set.

The atmosphere for an annealing process as described above may include oxygen therein. In that case, the oxygen concentration is preferably approximately 20%. This is because a sufficient effect can be obtained through an ordinary annealing in the air. In addition, it is preferable that the annealing process as described above be completed within less than two hours. For example, it is also sufficient to complete the process even within approximately 30 minutes. This is because as the annealing time becomes shorter, the destruction of the CNTs themselves stops progressing. However, the oxygen concentration described here is an example of the embodiment, and the present invention is not limited thereto. With regard to the annealing time, the annealing may be performed at a relatively low temperature, such as 200° C. to 260° C., within 2 hours or more.

In addition, among the CNTs contained in the CNT thin film due to the annealing process as described above, it is preferable that 50% or more of CNT skeletons be undamaged. This is because if 50% or more of the CNT skeletons become damaged or destroyed, the electrical resistance is significantly increased.

In addition, a main component of the CNTs configuring the CNT thin film formed as described above may be a single-wall nanotube. As described above, this is because as a bolometer material, a material containing a larger semiconductor component advantageously increases the temperature coefficient of resistance, the single-wall nanotube can separate the semiconductor component and a metal component from each other, and further a material containing a larger semiconductor component is easily manufactured, and the like.

[Transforming CNT Thin Film into Device]

The CNT thin film is used as an infrared sensor of the infrared sensor with a suitable structure. The infrared sensor may also be a sensor formed of a single device, and it may also be arranged two-dimensionally in an array so as to be used in an image sensor.

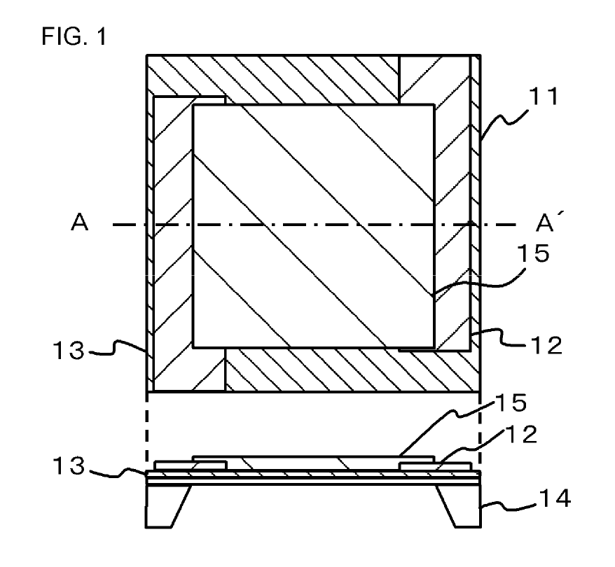

As illustrated in FIG. 1, each of infrared sensor devices 11 has a configuration in which a substrate such as a Si substrate 14 has a hollow structure therein, and a CNT thin film 15 is formed between two electrodes 12 formed on an insulating film 13.

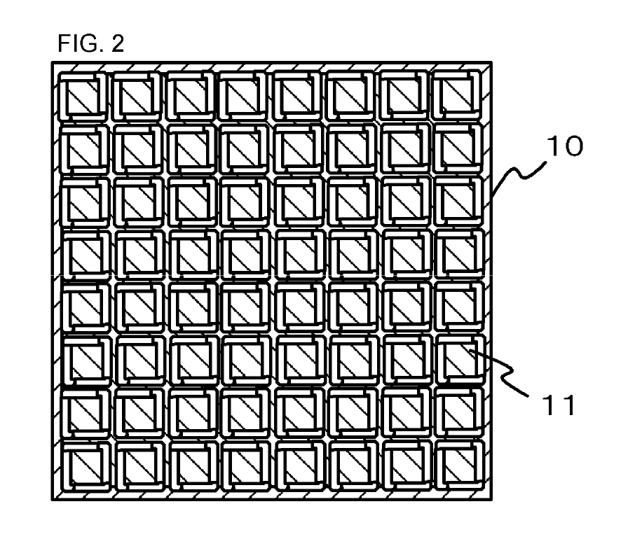

In order to obtain a two-dimensional image, for example, an array of the infrared sensor devices 11 which configure an infrared sensor 10, as illustrated in FIG. 2, is formed and imaging can be performed through an electric signal process using readout circuit thereon. In FIGS. 1 and 2, a peripheral portion of the readout circuit and the like are not illustrated.

However, the structure of the infrared sensor device 11 is not limited to the configuration illustrated in FIG. 1, but for example, the hollow portion may not be provided therein or a plastic substrate may be used instead of the Si substrate 14. A structure that can capture variations of the electrical resistance of the CNT thin film 15 due to the temperature change may be adopted.

The method of manufacturing the infrared sensor using the CNT thin film, for example, when manufacturing the infrared sensor in which the VOx in the related art is used as the infrared sensor material, only the conditions for forming a film with the infrared sensor material are different therefrom. Therefore, it is possible to be easily applied even to a microstructure such as an infrared image sensor using the infrared sensor.

In addition, the infrared sensor using the CNT thin film can also be applied to a sensor made of a plastic substrate such as a polyimide substrate, since it is possible to manufacture the infrared sensor even at temperatures less than 300° C. in a film formation process and the annealing process.

In addition, 90% or more of single-wall annotates may be a semiconductor component. When the SWNT shows semiconductor-like properties, the temperature coefficient of resistance tends in the negative direction. When the SWNT is metallic, the temperature coefficient of resistance tends in the positive direction.

In the SWNT thin film in a state in which they are mixed, a respectively added result represents a substantial temperature coefficient of resistance. In general, since the semiconductor-like temperature dependency is great, the temperature coefficient of resistance indicates a negative value.

Usually, the temperature coefficient of resistance of the semiconductor is negative. As the bolometer material, since there is a fact that a semiconductor for which the temperature coefficient of resistance is large is used, it is advantageous that 90% or more of the semiconductor component be contained therein. In numeric values, 50% or more of the semiconductor component, and more preferably 90% or more of the semiconductor component are contained.

### Embodiment

Hereinafter, by illustrating an embodiment, more detailed description will be given with regard to a CNT thin film of the present invention.

### Embodiment 1

10 mg of the SWNTs (manufactured by Southwest Nanotechnologies, Inc.) was placed in 100 mg of dichloroethane so as to be dispersed using ultrasonic waves and thus a CNT dispersion solution was prepared. In addition, the prepared CNT dispersion solution was diluted to have an appropriate concentration.

An appropriate amount of the CNT dispersion solution was dropped on a SiO₂ substrate, and the CNT thin film was prepared using a spin coating method (hereinafter, the CNT thin film formed on the SiO₂ substrate is simply referred to as the CNT thin film).

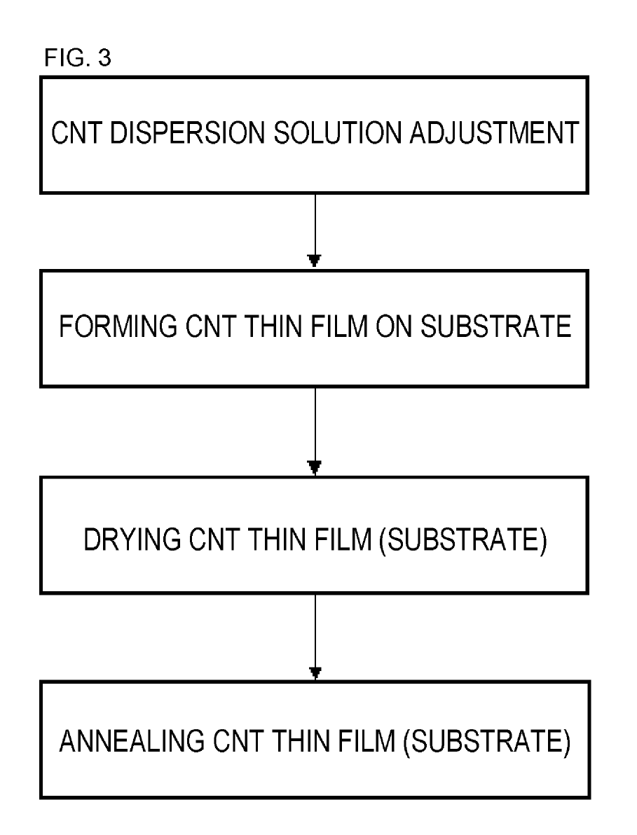

The CNT thin film described above was dried in an oven at 80° C. for 10 minutes, to evaporate excess solvent. In addition, the obtained CNT thin film was heated on a hot plate at 150° C. for approximately 30 minutes. The heated CNT thin film I was annealed in the air at 280° C. for one hour. A series of processes of manufacturing the CNT thin film which is shown here is summarized in FIG. 3.

### Embodiment 2

The CNT thin film prepared in the same manner as in Embodiment 1 was annealed in the air at 200° C. for one hour.

### Embodiment 3

The CNT thin film prepared in the same manner as in Embodiment 1 was annealed in the air at 240° C. for one hour.

### Embodiment 4

The CNT thin film prepared in the same manner as in Embodiment 1 was annealed in the air at 320° C. for one hour.

### Comparative Example 1

10 mg of the SWNTs (manufactured by Southwest Nanotechnologies, Inc.) was placed in 100 mg of dichloroethane so as to be dispersed using ultrasonic waves and thus a CNT dispersion solution was prepared. In addition, the prepared CNT dispersion solution was diluted to have an appropriate concentration.

An appropriate amount of the CNT dispersion solution was dropped on a SiO₂ substrate, and the CNT thin film was prepared using a spin coating method (hereinafter, the CNT thin film formed on the SiO₂ substrate is simply referred to as the CNT thin film). The CNT thin film described above was dried in an oven at 80° C. for 10 minutes, to evaporate excess solvent. In Comparative Example 1, after drying of the CNT thin film at 80° C., a special heat treatment was not applied thereto.

### Comparative Example 2

The CNT thin film prepared in the same manner as in Comparative Example 1 was heated for 30 minutes on a hotplate at 150° C. In Comparative Example 2, after drying of the CNT thin film at 150° C., a special heat treatment was not applied thereto.

### Comparative Example 3

The CNT thin film prepared in the same manner as in Comparative Example 1 was heated for 30 minutes on a hotplate at 150° C. In Comparative Example 3, an additional annealing was performed in the air at 350° C. for one hour.

### Comparative Example 4

The CNT thin film prepared in the same manner as in Comparative Example 1 was heated for 30 minutes on a hotplate at 150° C. In Comparative Example 4, an additional annealing was performed in the air at 280° C. for two hours.

### Comparative Example 5

The CNT thin film prepared in the same manner as in Comparative Example 1 was heated for 30 minutes on a hotplate at 150° C. In Comparative Example 5, an additional annealing was performed in the air at 280° C. for three hours.

### [Experimental Results]

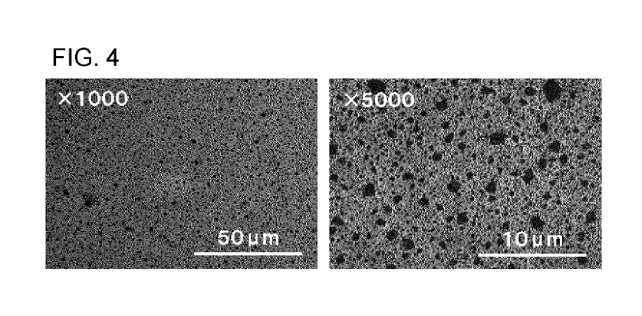

A surface SEM image of the CNT thin film prepared in Embodiment 1 is illustrated in FIG. 4. At low magnification (×1000), a uniform film formation could be confirmed, and it seemed that uniform pores had been formed therein.

At high magnification (×5000), it could be confirmed that relatively small pores and relatively large pores were carved and dotted, and thereby these were derived from the network structure of CNT.

The thickness of the CNT thin film in the Embodiments and the Comparative Examples was measured as follows. First, by dividing the SiO₂ substrate coated with CNT thin film, a cross-section thereof was exposed. Then the thickness of the CNT thin film was measured by observing the cross-section using the SEM.

The film thickness of the CNT thin film shown in the embodiments and comparative examples was in the range of 0.5 μm to 1.0 μm, and the average film thickness was 0.7 μm to 0.8 μm. In addition, due to forming conditions of the CNT thin film and depending on variation in partial destruction of the CNTs through the annealing process, actual numerical values varied.

The electrical measurement results of the sample are illustrated in FIGS. 5 and 6. FIG. 5 illustrates the variation in the temperature coefficient of resistance (TCR), and FIG. 6 illustrates the variation in the electrical resistance, depending on the annealing temperature. In the electrical measurement, a foil-like electrode is put on a surface of each sample so that an optimal current value flows to each sample, thereby measuring the temperature change of the voltage value (−10° C. to 50° C.)

As the infrared sensor material, it is required that the absolute value of the TCR is large and the electric resistance be small. It can be confirmed that when determined from this requirement, those having slightly larger electrical resistance and in a viewpoint of the TCR, the sample of Embodiment 1 were most preferable.

In the samples of Embodiments 2 and 3, although the absolute value of the TCR exceeded one %, it could be confirmed that the samples were inferior to the sample of Embodiment 1. In addition, in the sample of Embodiment 4, since the TCR decreased and the electrical resistance increased twofold, it could be confirmed that it is undesirable if the annealing temperature is too high.

In fact, in the sample of Comparative Example 3, since the CNT itself began to destroy, it was not possible to measure a significant increase in the electrical resistance. In addition, in Comparative Example 1 and Comparative Example 2, it could be confirmed that the annealing effect could not be sufficiently obtained.

In Comparative Example 4, the TCR was −1.6%/K, but the electric resistance increased to 50 MΩ. In addition, in Comparative Example 5, it was not possible to measure a significant increase in the electrical resistance. Increasing the annealing time resulted in the fact that percentage of the CNTs destroyed in the CNT thin film increased. That is, it is preferable that the annealing time in a case of annealing at 280° C. be set to less than two hours.

As described above, using the method of the present invention, it can be confirmed that an optimal infrared sensor material suitable for the infrared sensor can be obtained. In addition, it is apparent that the present invention is not limited to the above embodiments, and may be modified and changed without departing from the scope and spirit of the present invention.

This application is based on Japanese Patent Application No. 2010-230225 filed in the Japanese Patent Office on Oct. 13, 2010, the entire content of which is incorporated hereinto by reference.

What is claimed is:

1. A method of manufacturing an infrared sensor material, comprising:
preparing a CNT dispersion solution by dispersing a Carbon Nanotube (CNT) in a solvent;
forming a CNT thin film using the CNT dispersion solution as a raw material; and
annealing the CNT thin film so that an absolute value of a temperature coefficient of resistance is equal to or more than 1%/K at a temperature of −10° C. to 50° C.

2. The method of manufacturing the infrared sensor material according to claim 1,
wherein an atmosphere for performing the annealing process includes oxygen.

3. The method of manufacturing the infrared sensor material according to claim 1,
wherein a temperature for performing the annealing process is within the range of 200° C. to 340° C.

4. The method of manufacturing the infrared sensor material according to claim 1,
wherein a time for performing the annealing process is less than 2 hours.

5. The method of manufacturing the infrared sensor material according to claim 1,
wherein 50% or more of a CNT skeleton within the CNT to be contained in the CNT thin film is not damaged through the annealing process.

6. An infrared sensor material manufactured by a manufacturing method according to claim 1,
wherein the absolute value of the temperature coefficient of resistance is equal to or more than 1%/K at a temperature of −10° C. to 50° C.

7. An infrared sensor material, comprising:
a CNT thin film in which an absolute value of the temperature coefficient of resistance is equal to or more than 1%/K at a temperature of −10° C. to 50° C.

8. The infrared sensor material according to claim 6,
wherein a main component of the CNT configuring the CNT thin film is a single wall nanotube.

9. The infrared sensor material according to claim 8,
wherein 90% or more of the single wall nanotube is a semiconductor component.

10. An infrared sensor device using the infrared sensor material according to claim 6.

11. An infrared image sensor wherein the infrared sensor devices according to claim 10 are arranged in a two-dimensional shape.
